(19) United States
(12) Patent Application Publication
(10) Pub. No.: US 2004/0040408 A1
(43) Pub. Date: Mar. 4, 2004

(54) Pedal emulator assembly and method

(75) Inventors: Schuyler S. Shaw, Dayton, OH (US); Paul F. Flanagan, Dayton, OH (US)

Correspondence Address: DELPHI TECHNOLOGIES, INC., Legal Staff, Mail Code: 480-410-202, Troy, MI, 48007, US

(73) Assignee: DELPHI TECHNOLOGIES INC.

(21) Appl. No.: 10/338,385

(22) Filed: Jan. 8, 2003

Related U.S. Application Data
(60) Provisional application No. 60/406,177, filed on Aug. 27, 2002.

(51) Int. Cl. G05G 1/14

(52) U.S. Cl. 74/560

(57) ABSTRACT

A pedal emulator assembly and method for a motor vehicle. The assembly includes at least one pedal for generating a dynamic reaction force against an applied pedal force. The pedal is deformed as a result of the applied pedal force. The assembly further includes at least one sensor operably attached to the pedal for estimating the applied pedal force based on the pedal deformation. The method includes deforming at least one pedal with an applied pedal force. A dynamic reaction force is generated against the applied pedal force with the pedal. The applied pedal force is estimated based on the pedal deformation.

### RELATED APPLICATIONS

This application claims the benefit of U.S. Provisional Application No. 60/406,177, filed Aug. 27, 2002, entitled Composite Pedal Emulator Assembly, by Schuyler S. Shaw, et al.

### TECHNICAL FIELD OF THE INVENTION

The present invention relates generally to vehicular pedal assemblies. More particularly, the invention relates to a pedal emulator assembly and method.

### BACKGROUND OF THE INVENTION

Conventional vacuum boosted brake apply systems utilize a direct application of pedal-to-brake force via hydraulic fluid. Drivers have become accustomed to the pedal response or “feel” generated by such systems. With brake-by-wire (BBW) or similar type of vehicle braking system, however, the application of braking force to the wheel brakes is generated by an electric or an electro-hydraulic controlled means. This changes the BBW pedal feel characteristics at the vehicle's brake pedal from those conventional apply systems and prevents the driver from experiencing the customary brake pedal feel. Therefore, strategies have been developed for emulating pedal feel that drivers are accustomed.

Known BBW systems that generate a pedal feel consistent with that of conventional vacuum boosted apply systems may utilize a master cylinder assembly to emulate pedal feel. The brake pedal feel is typically transparent to the driver when compared to the conventional vacuum boosted apply systems. Examples of such emulators include U.S. Pat. Nos. 5,729,979 and 6,367,886 to Shaw, which are incorporated by reference herein. Such brake pedal emulators may include (sequentially compressible) springs or other biasing members and restrictive fluid flow paths to generate non-linear reaction force versus pedal travel (e.g., movement of the pedal) consistent with conventional apply systems. These emulator elements are typically carried within the master cylinder assembly.

Although such assemblies may provide adequate brake pedal travel and feel characteristics, use of a master cylinder including emulator elements adds to the cost and size of the brake pedal assembly. As such, it would be desirable to provide a non-linear reaction force to pedal travel assembly and method that do not require a master cylinder or like mechanisms to generate pedal feel consistent with vacuum boosted brake apply systems.

Unlike the non-linear reaction force versus travel output of brake pedals, the accelerator, clutch, and emergency brake pedals typically exhibit a linear response that is much simpler mechanically to provide. Nevertheless, the use of spring(s) or like biasing elements to generate the pedal feel may add to the cost of the pedal assembly. As such, it would be desirable to provide a linear reaction force to pedal travel assembly and method without the need for external springs or like elements to generate the desired pedal feel.

Strategies for adjusting pedal assembly position relative to the vehicle chassis and driver are known. Examples of such strategies include U.S. Pat. No. 6,360,629 to Schambre et al. and U.S. Pat. No. 6,453,767 to Willemsen et al., which are incorporated by reference herein. The strategy involves mounting the pedal of a pivoting shaft thereby allowing a controlled rotational position adjustment. Additionally, the pedal may be adjusted in a longitudinal fashion parallel to the vehicle floor via a pivot pin and slot structure. Adjustment of the pedal(s) through at least one range of motion may provide ergonomic customization of the vehicle to the driver thereby enhancing the driving experience. As such, it would be desirable to provide a pedal assembly and method with a positional adjustment feature.

Therefore, it would be desirable to provide a pedal emulator assembly and method that overcomes the aforementioned and other disadvantages.

### SUMMARY OF THE INVENTION

One aspect of the present invention provides a pedal emulator assembly for a motor vehicle. The assembly includes at least one pedal for generating a dynamic reaction force against an applied pedal force. The pedal is deformed as a result of the applied pedal force. The assembly further includes at least one sensor operably attached to the pedal for estimating the applied pedal force based on the pedal deformation.

Another aspect of the invention provides a method of operating a pedal emulator assembly for a motor vehicle. The method includes deforming at least one pedal with an applied pedal force. A dynamic reaction force is generated against the applied pedal force with the pedal. The applied pedal force is estimated based on the pedal deformation.

Another aspect of the present invention provides a pedal emulator assembly for a motor vehicle. The assembly includes means for deforming a pedal with an applied pedal force, means for generating a dynamic reaction force against the applied pedal force, and means for estimating the applied pedal force.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIGS. 1A and 1B are “front” and “side” perspective views of a first pedal emulator assembly for a motor vehicle in accordance with the present invention;

FIG. 2 is a schematic diagram of the pedal emulator assembly of FIGS. 1A and 1B shown mounted on a vehicle floor in accordance with the present invention;

FIG. 3 is a graph of reaction force versus pedal travel for a brake pedal and an accelerator pedal in accordance with the present invention;

FIG. 4 is a schematic diagram of a second pedal emulator assembly in accordance with the present invention; and

FIG. 5 is a “side” perspective view of a third pedal emulator assembly in accordance with the present invention.

### DESCRIPTION OF THE PRESENTLY PREFERRED EMBODIMENTS

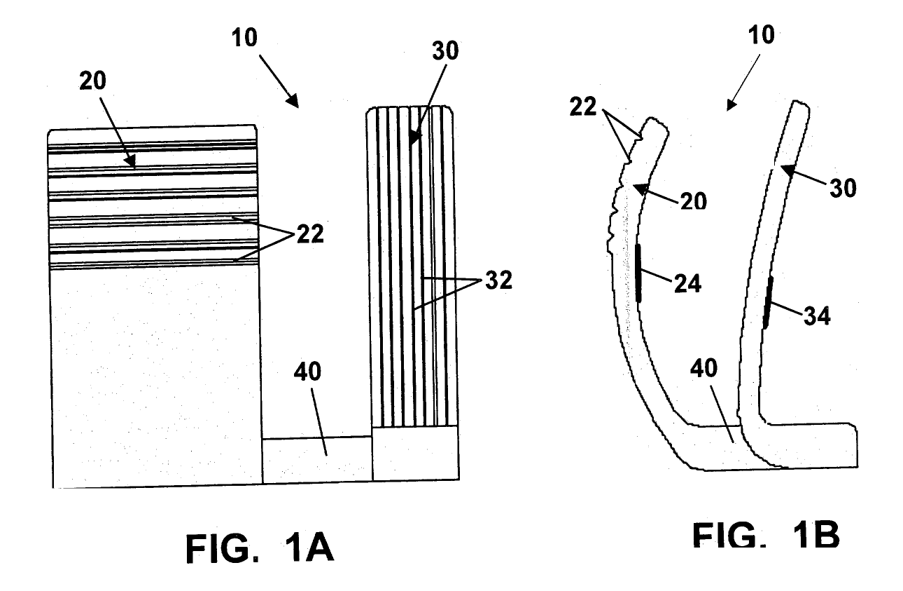

Referring to the drawings, wherein like reference numerals refer to like elements, FIGS. 1A; and 1B are “front” and “side” perspective views of a pedal emulator assembly 10 for a motor vehicle in accordance with the present invention. Assembly 10 includes at least one pedal, in this case a brake pedal 20 and accelerator pedal 30. Pedals 20, 30 may be manufactured from one or more resilient materials such as plastic, rubber, acrylic, silicone, vinyl, urethane, metal, metal alloy, and combinations thereof. The brake pedal 20 and accelerator pedal 30 may constitute a single unit joined by a base portion 40. Assembly 10 may be manufactured during a relatively simple extrusion process thereby reducing unit cost.

Those skilled in the art will recognize that the pedal emulator assembly may include numerous variations in design and material constitution. In another embodiment, the assembly may optionally include a clutch pedal, a parking brake pedal, and/or other pedals for controlling a vehicle function. Furthermore, the assembly pedal(s) may be manufactured from any number of resilient materials, as a single (attached) unit, as shown, or as multiple-part (separate) units. For example, the pedal(s) may be partially manufactured from durable materials (e.g., metals, alloys, hard plastics, and the like) to reduce wear and failure rate.

Pedals 20, 30 may be conventionally shaped conforming to a driver foot. A plurality of ridges 22, 32 may be formed on the pedal 20, 30 surfaces to provide increased friction with the driver foot. Pedals 20, 30 each include one or more operably attached sensors 24, 34 for estimating an applied pedal force. In one embodiment, one or more of the sensors 24, 34 may be fiber optic transducers known in the art that optically estimate pedal force as a function of light scattering. In another embodiment, one or more of the sensors 24, 34 may be strain gauge type sensors known in the art for estimating pedal force as a function of strain in the pedal material. Those skilled in the art will recognize that any number, variety, or combination of sensors may be operably attached to the assembly pedal(s) for estimating applied pedal force.

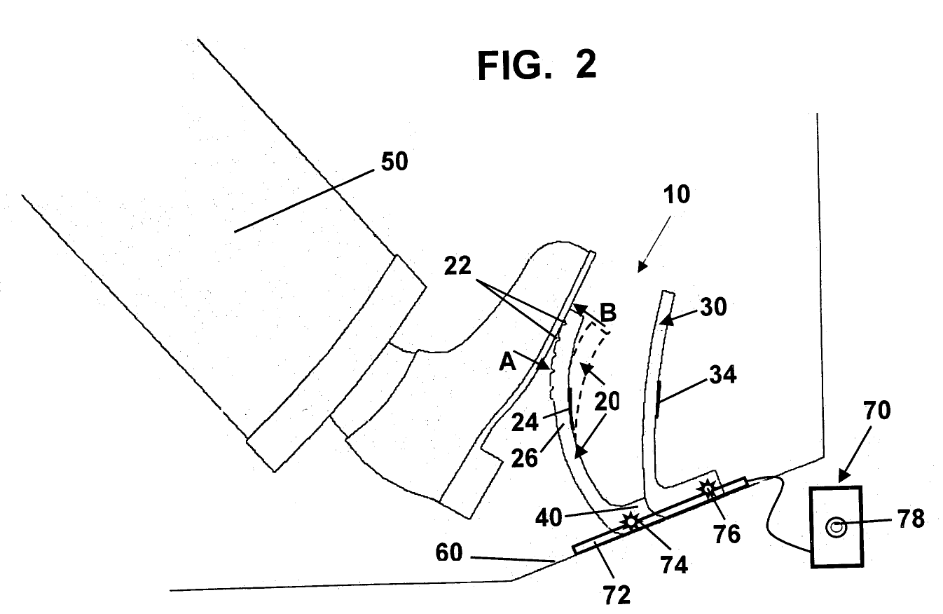

Referring to FIG. 2, the assembly 10 may be mounted to a vehicle floor 60. The mounting position of the assembly 10 relative to the floor 60 may vary for each vehicle and is typically adjusted for ergonomic driver 50 operation. To further allow positional adjustment, the assembly 10 may include a position adjustment feature 70. In one embodiment, the adjustment feature 70 may include one or more mechanical track(s) 72 to which corresponding gear(s) 74 turned by motor(s) 76 provide position adjustment. A switch 78 may be electrically coupled to the motor(s) 76 allowing the driver 50 to adjust the assembly 10 position as desired. In another embodiment, a pivot pin and slot may provide rotational position adjustment of the assembly. It will be appreciated that numerous pedal assembly position adjustment strategies are known in the art and may be adapted for use with the present invention.

In yet another embodiment, the adjustment feature 70 may provide positional adjustment of the assembly 10 so as to prevent unauthorized operation of the motor vehicle. For example, the assembly 10 position may be adjusted against a driver's seat (not shown) and/or rotated against the floor 60 to prevent a driver from physically accessing the pedals 20, 30. As such, vehicle operation may be selectively permitted thus providing a security feature that may prevent vehicle theft or accidental use. Those skilled in the art will recognize that the assembly 10 may be adjusted in a variety of positions to prevent physical access to the pedals 20, 20 and therefore unauthorized use of the vehicle.

During operation of the assembly 10, driver 50 foot applies a pedal force A to the pedal 20. The pedal force A may be a brake pedal force, an accelerator pedal force, a clutch pedal force, a parking brake pedal force, and the like, depending on the type of the pedal 20. As the driver 50 depresses the pedal 20, an opposing dynamic reaction force B is generated against the applied pedal force A. The pedal 20 is deformed as a result of the applied pedal force A representing a “travel” of the pedal 20. In the present application, the term “deform” and derivatives thereof are set to mean a physical change in a pedal geometry that results from an applied pedal force. As shown in FIG. 2, pedal 20 is deformed to the right (dashed lines) with respect to the base portion 40. As the applied pedal force A increases, the opposing dynamic reaction force B increases thereby providing a characteristic pedal feel. The opposing dynamic reaction force may vary and is typically different from pedal type to pedal type.

In one embodiment, a linear reaction force to pedal travel characteristic may be provided, which is usually associated with accelerator, clutch, and parking brake type pedals. In another embodiment, a non-linear reaction force to pedal travel characteristic may be provided, which is usually associated with brake type pedals. Regardless of the type of reaction force to pedal travel characteristic provided, the pedal(s) of the present invention can generate the described pedal feel without the need for a master cylinder, external springs, or other mechanical devices. The absence of such parts may reduce unit cost and size, increase reliability (i.e., less moving parts), and simplify the manufacture process.

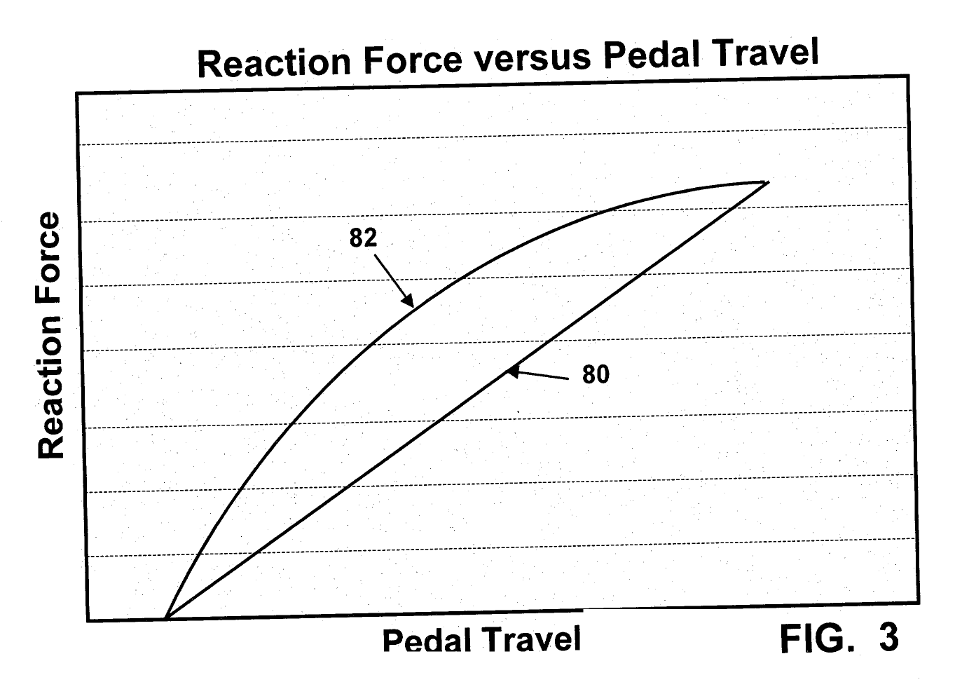

FIG. 3 is a graph representing exemplary reaction force versus pedal travel for two pedal types. An accelerator reaction force versus pedal travel curve 80 and a brake reaction force versus pedal travel curve 82 are shown representing characteristic pedal feel. The accelerator pedal travel curve 80 may be a linear function representing a nominally increasing reaction force with increasing pedal travel. The brake pedal travel curve 82 may be non-linear functions representing exponentially increasing reaction force with increasing pedal travel. Brake pedals with a like reaction force versus pedal travel curve 82 may provide a desirable pedal feel consistent with conventional vacuum boosted apply systems. Those skilled in the art will recognize that the pedals of the present invention are not limited to the exemplary pedal response curves. The inventors contemplate numerous other linear and non-linear reaction forces to pedal travel functions with respect to the present invention.

Referring again to FIG. 2, the applied pedal force A deforms the pedal 20 which is sensed by the sensor 24. As the pedal 20 may be manufactured from a resilient material, the pedal 20 can be repeatedly deformed by flexing and extending with numerous pedal force A application cycles. In one embodiment, as shown, the pedal 20 may deform at one or more positions, which in this case is a hinge portion 26. The pedal force A may be estimated with the sensor 24 by monitoring the degree to which the pedal 20 material flexes or extends at or near the hinge portion 26. The hinge point 26 may provide an optimal location to sense pedal 20 deformation via a strain gauge type sensor as it is typically an area of great material stress during use. As such, the strain type gauge sensor may detect an applied pedal force with greater sensitivity when sensing the hinge point 26.

In another embodiment, one or more reference points may provide an optimal location to sense pedal 20 deformations via a fiber optic transducer or like sensor. The reference point is typically positioned at an area that exhibits a high degree of pedal 20 movements or travel. As such, the fiber optic type sensor may optically detect an applied pedal force with greater sensitivity when sensing the reference point. In yet another embodiment, the sensor 24 may sense another portion of the pedal 20 to optimally detect pedal 20 deformations thereby allowing accurate and precise applied pedal force estimation.

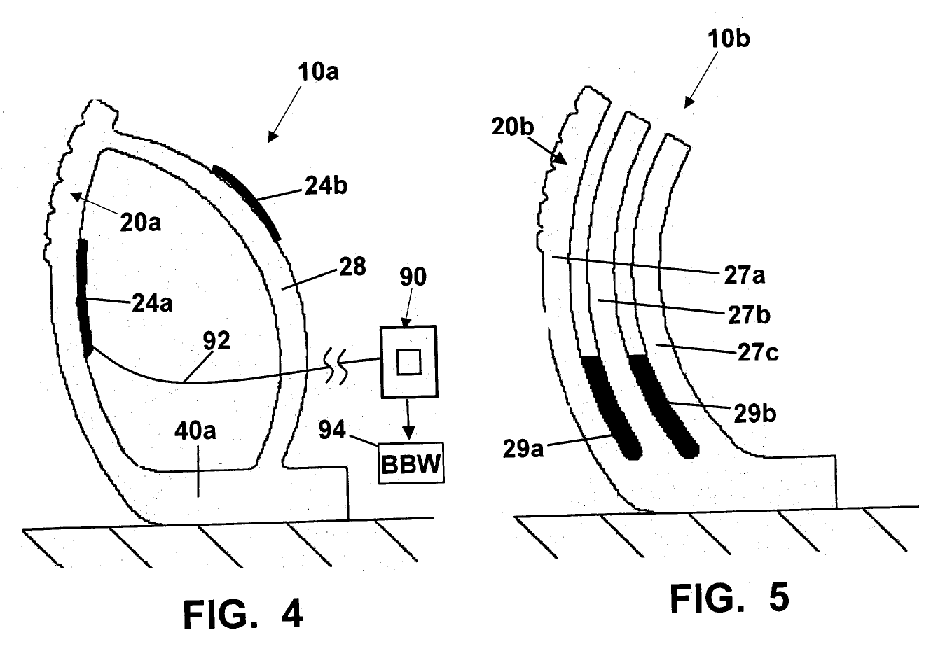

Turning now to FIG. 4, a schematic diagram of an alternate embodiment pedal assembly 10a is shown. Assembly 10a includes a brake pedal 20a with a reinforcing member 28 attached to the brake pedal 20a and a base portion 40a. Reinforcing member 28 provides an additional dynamic reaction force to an applied pedal force. Assembly 10a further includes a sensor 24a mounted on a back portion of the pedal 20a. Sensor 24a is advantageously mounted at a location adjacent where the pedal 20a material undergoes a mechanical flexion/extension during application of the brake pedal force thereby allowing for force estimation. A sensor 24b is shown mounted in an alternate position to achieve essentially the same function as sensor 24a.

In one embodiment, applied pedal force estimation may be performed by the sensor 24a and a signal based on the estimated force may be sent to a vehicle control system 90 via a wire 92. The vehicle control system 90 may be one or more systems for performing a vehicle function including, but not limited to, a brake-by-wire system 94, accelerator, parking brake, clutch, and the like. Typically, the vehicle control system, such as the brake-by-wire system 94, is activated in proportion to the applied pedal force. In another embodiment, the sensor 24a may sense pedal 20a deformation and relay this information to a micro-processing unit for estimating the applied pedal force. The estimation may be achieved, for example, by using a look-up table of material strain/pedal travel versus applied pedal force for a given pedal 20a. Compensation for factors such as material wear state and temperature, which may affect the applied pedal force estimation, may be included in the look-up table.

FIG. 5 is a “side” perspective view of an alternate embodiment pedal assembly 10b is shown. Assembly 10b includes a brake pedal 20b with a plurality of members 27a, 27b, and 27c, in this case three, spaced apart from each other. At least one filler material 29a, 29b, in this case two, may be operably attached to the pedal 20b for tuning the dynamic reaction force. The filler material 29a, 29b may be manufactured from any number of materials capable of stiffening pedal deformation or travel. Those skilled in the art will recognize that the constitution, size, position, and geometry of the filler material may vary to provide alternate reaction force tunings. In the pictured embodiment, the filler material 29a, 29b is positioned in the pedal member 27a, 27b, and 27c interstices. In another embodiment, the filler material may be positioned, for example, within the pedal interior or, alternately, surrounding one or more pedal members 27a, 27b, and 27c.

During operation of the pedal 20b, a first dynamic reaction force may be generated against an applied pedal force until member 27a moves laterally (to the right direction in FIG. 5) into engagement with member 27b. First filler material 29a may effectively stiffen the lateral movement of the member 27a augmenting the first dynamic reaction force. As member 27b engages member 27a, a second dynamic reaction force is generated against the applied pedal force.

As the applied pedal force increases, engaged members 27a, 27b move laterally (to the right direction in FIG. 5) into engagement with member 27c. Second filler material 29b may effectively stiffen the lateral movement of the members 27a, 27b augmenting the second dynamic reaction force. As members 27a, 27b engage member 27c, a third dynamic reaction force is generated against the applied pedal force. As such, the sequential engagement of members 27a, 27b, and 27c one to another provide a multistage increasing dynamic reaction force. In this manner, complex characteristic feel relationships can be generated thus emulating numerous mechanical assemblies including conventional vacuum boosted apply brake systems.

While the embodiments of the invention disclosed herein are presently considered to be preferred, various changes and modifications can be made without departing from the spirit and scope of the invention. For example, the described pedal emulator assembly and method are not limited to any particular design or sequence. Specifically, the pedal number, type, material, geometry, and position, sensor, filler material, dynamic reaction force and travel characteristics may vary without limiting the utility of the invention. Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A pedal emulator assembly for a motor vehicle, the assembly comprising:
at least one pedal for generating a dynamic reaction force against an applied pedal force, wherein the pedal is deformed as a result of the applied pedal force; and
at least one sensor operably attached to the pedal for estimating the applied pedal force based on the pedal deformation.

2. The assembly of claim 1 wherein the at least one pedal is selected from a group consisting of a brake pedal, an accelerator pedal, a clutch pedal, and a parking brake pedal.

3. The assembly of claim 1 wherein the pedal is manufactured from a resilient material.

4. The assembly of claim 3 wherein the resilient material comprises at least one material selected from a group consisting of a plastic, rubber, acrylic, silicone, vinyl, urethane, metal, metal alloy, and combinations thereof.

5. The assembly of claim 1 wherein the dynamic reaction force comprises a linear reaction force to pedal travel characteristic.

6. The assembly of claim 1 wherein the dynamic reaction force comprises a non-linear reaction force to pedal travel characteristic.

7. The assembly of claim 1 wherein the pedal comprises a plurality of members spaced apart from each other, the members sequentially engaging one to another with increasing applied pedal force to provide the dynamic reaction force.

8. The assembly of claim 1 wherein the sensor is a fiber optic transducer.

9. The assembly of claim 1 wherein the sensor is a strain gauge-type transducer.

10. The assembly of claim 1 further comprising a position adjustment feature operably attached to the pedal for adjusting a pedal emulator assembly position with respect to a vehicle floor.

11. The assembly of claim 10 wherein the position adjustment feature comprises means for preventing unauthorized operation of the motor vehicle.

12. The assembly of claim 1 further comprising at least one filler material operably attached to the pedal for tuning the dynamic reaction force.

13. A method of operating a pedal emulator assembly for a motor vehicle, the method comprising:
deforming at least one pedal with an applied pedal force;
generating a dynamic reaction force against the applied pedal force with the pedal; and
estimating the applied pedal force based on the pedal deformation.

14. The method of claim 13 wherein deforming the at least one pedal comprises applying a pedal force selected from a group consisting of a brake pedal force, an accelerator pedal force, a clutch pedal force, and a parking brake pedal force.

15. The method of claim 13 wherein generating the dynamic reaction force comprises generating a linear reaction force to pedal travel characteristic.

16. The method of claim 13 wherein generating the dynamic reaction force comprises generating a non-linear reaction force to pedal travel characteristic.

17. The method of claim 13 wherein generating the dynamic reaction force comprises sequentially engaging a plurality of members spaced apart from each other during applied pedal force increases.

18. The method of claim 13 wherein estimating the applied pedal force comprises optically detecting the pedal deformation.

19. The method of claim 13 wherein estimating the applied pedal force comprises detecting strain in the pedal deformation.

20. The method of claim 13 further comprising adjusting pedal emulator assembly position with respect to a vehicle floor.

21. The method of claim 20 wherein adjusting pedal emulator assembly position comprises preventing unauthorized operation of the motor vehicle.

22. The method of claim 13 further comprising sending a signal based on the estimated applied pedal force to a vehicle control system.

23. A pedal emulator assembly for a motor vehicle, the assembly comprising:
means for deforming a pedal with an applied pedal force;
means for generating a dynamic reaction force against the applied pedal force; and
means for estimating the applied pedal force.
